(19) United States
(12) Patent Application Publication
(10) Pub. No.: US 2026/0274520 A1
(43) Pub. Date: Sep. 17, 2026

(54) REINFORCED BULK BAG AND METHOD OF CONSTRUCTION

(71) Applicant: Global-Pak, Inc., Lisbon, OH (US)

(72) Inventor: Jeff Carner, Lisbon, OH (US)

(73) Assignee: Global-Pak, Inc., Lisbon, OH (US)

(21) Appl. No.: 19/081,469

(22) Filed: Mar. 17, 2025

Related U.S. Application Data
(60) Provisional application No. 63/566,953, filed on Mar. 19, 2024.

(51) Int. Cl. B65D 33/06; B65D 30/00

(52) U.S. Cl. CPC B65D 33/06; B65D 29/00

(57) ABSTRACT

A bag for carrying a load of solid particulate materials and a method of constructing the same. The bag includes a first member produced from a flexible sheet material, such as a woven fabric, and is generally circular in cross-section. The first member is transformed into a second member which is generally square in cross-section. The first member is woven as a tube defining a bore therethrough. In order to transform the first member to the second member, four longitudinally-extending reinforced regions are woven into the fabric of the tube. A longitudinally-extending fold is formed in each reinforced region to create a pleat. A lift belt is secured along each pleat so that a loop of the lift belt extends beyond a first end of the tube. A second end of the tube is closed off to transform the bore therein into the cavity for receiving the load.

### CROSS REFERENCE TO RELATED APPLICATIONS

This application claims priority from U.S. Provisional Application Ser. No. 63/566,953 filed Mar. 19, 2019; the disclosure of which is incorporated herein by reference.

### TECHNICAL FIELD

This disclosure generally relates to containers for carrying a load. More particularly, this disclosure is directed to a flexible bag for carrying solid, particulate materials such as sand or mulch. Specifically, the disclosure relates to a flexible bag which is formed from a tubular sleeve into which are formed a plurality of corners in regions of the bag of greater density, wherein the introduction of the corners changes the configuration of the bag from being generally circular in cross section to generally square in cross section. The bag is provided with lift belts at the corners to enable the bag to be lifted and manipulated.

### BACKGROUND ART

Flexible intermediate bulk containers (FIBCs) have become a standard for transporting dry solid particulates such as sand and mulch. A number of different bulk bags types are currently in use. These include single use bulk bags and multi-use bulk bags. Single use bulk bags should only be filled once and discharged once. Multi-use bags (also known as “multi-trip” bags) are specially designed and manufactured in such a way as to be used more than once. Multi-use bags are rated at a 6:1 safety factor ratio meaning that they have the ability to hold six times their rated safe working load. Finally, UN-Rated bulk bags are used to transport hazardous materials. These bags require special testing to meet UN Safety Standards.

A number of different bag constructions are known. Four-panel bags are fabricated from four separate pieces of polypropylene fabric which are sewn together along seams in such a way as to form a front panel, a back panel, and two opposing side panels extending between the front and back panels. A bottom wall panel is sewn to bottom ends of the four panels. In order to lift or carry a loaded FIBC, lift belts with loops are provided and these lift belts are sewn to the exterior surface of the bag close to the corner seams. A loop provided on each lift belt extends above a top end of the bag. Typically, four-panel bags have a capacity of up to 4400 LBS. Four-panel bags are particularly prone to being damaged if the bag is accidentally dropped while being lifted and moved because the bag's seams have a tendency to split when these bags are dropped. In order to try and prevent this from happening, the GSM of the fabric is increased to make the bag stronger and therefore less prone to tearing. However, increasing the GSM increases the cost of these bags.

Circular or tubular bags are made from fabric which has been woven on a circular loom to form a tubular shape. The fabric is woven into a continuous tube of fabric and is then cut to the correct size height. The bottom of the tube is closed off but may, in some instances, be arranged so as to later be usable as a spout. Cross-corner lift belts are sewn onto the exterior circumferential surface of the tubular body. A cross-corner lift belt has a first end and a second end sewn to the tubular body a circumferential distance apart from one another and so that the loop extends above the top end of the tube. The tubular body design is ideal as a liner-free option for carrying finer particulate materials. It is also an excellent alternative to the original four-panel bag construction. Typically, the capacity of a tubular bag is up to 4000 lbs. Tubular bags tend not to split open if dropped because they include fewer seams than four-panel bulk bags. However, a drawback of existing tubular FIBCs with lift belts is that the failure point is usually due to the failure of the fabric under the cross-corner lift loops.

U-panel bags are formed from three pieces of fabric, with one piece being an elongated rectangle and the other two pieces being square. The rectangle is arranged into a U-shape to form the bottom wall and two opposing panels of the bag. Each of the square pieces is then sewn to the U-shape along a bottom edge and along two opposing side edges to form the remaining two panels of the bag. This style of bulk bag has become the industry standard in the United States. U-panel bags are less prone than four-panel bags to splitting along their seams but these bags may still have a tendency for the bags to be damaged in areas where the lift belts are secured to the bag fabric.

Some bulk bags include internal baffles, i.e., panels which are sewn into the interior of the bags near the corners in order to help keep the bag's shape and make the bag easier to fill, stack and transport.

### SUMMARY OF THE INVENTION

A bag for carrying a load of solid particulate materials and a method of constructing the same is disclosed herein. The bag includes a first member produced from a flexible sheet material, such as a woven fabric, and is generally circular in cross-section. The first member is transformed into a second member which is generally square in cross-section. The first member is woven as a tube defining a bore therethrough. In order to transform the first member to the second member, four longitudinally-extending reinforced regions are woven into the fabric of the tube. A longitudinally-extending fold is formed in each reinforced region to create a pleat. A lift belt is secured along each pleat so that a loop of the lift belt extends beyond a first end of the tube. A second end of the tube is closed off to transform the bore therein into the cavity for receiving the load.

In one aspect, an exemplary embodiment of the present disclosure may provide a bulk bag for carrying a load, said bag comprising a first member produced from a flexible sheet material, said first member being generally circular in cross-section; a second member formed from the first member, said second member being generally square in cross-section; and a cavity defined in the second member, said cavity being adapted to receive the load therein.

In one embodiment, wherein the first member may include a peripheral wall produced from the flexible sheet material, said peripheral wall being tubular in configuration and extending longitudinally from a first end to a second end, wherein the peripheral wall is generally circular in cross-section. In one embodiment, the bag may further comprise a plurality of pleats formed in the peripheral wall at circumferentially spaced-apart intervals from one another, wherein each pleat of the plurality of pleats extends longitudinally along the peripheral wall; a lift belt secured longitudinally along each pleat; and wherein the peripheral wall with the plurality of pleats formed therein along with the lift belt secured to each pleat comprises the second member. In one embodiment, the bag may further comprise a plurality of reinforced regions provided in the peripheral wall at the circumferentially spaced-apart intervals from one another; wherein the plurality of reinforced regions may extend longitudinally along the peripheral wall; and wherein each pleat of the plurality of pleats is formed in a different reinforced region of the plurality of reinforced regions.

In one embodiment, the flexible sheet material which forms the peripheral wall may comprise a woven fabric. In one embodiment, wherein the bag may further comprise a plurality of regions of a first thread density formed in the woven fabric; wherein a rest of the woven fabric is of a second thread density; wherein the first thread density is greater than the second thread density; and wherein each pleat of the plurality of pleats may be formed in one of the plurality of regions of the first thread density. In one embodiment, wherein the lift belt may comprise a first side and a second side, wherein the first side and the second side are in abutting contact with one another; wherein the first side is in abutting contact with a first surface of the pleat, and wherein a loop of the lift belt extends outwardly beyond a first end of the second member. In one embodiment, wherein the lift belt may comprise a first side and a second side, wherein the first side is in abutting contact with a first surface of the pleat and the second side is in abutting contact with a second surface of the pleat, wherein the first surface and the second surface of the pleat are opposed, and wherein a loop of the lift belt extends outwardly beyond a first end of the second member.

In one aspect, an exemplary embodiment of the present disclosure may provide a method of forming a bag comprising producing a first member having a first cross section; defining a bore in the first member, wherein the bore extends through the first member from a first opening in a first end to a second opening in a second end; forming a second member from the first member; changing the first cross section of the first member to a second cross section of the second member, wherein the second cross section is different from the first cross section; and closing the second opening to the bore to form a cavity in the second member, wherein the cavity is adapted to carry a load.

In one embodiment, producing the first member may include producing a tube from a flexible sheet material, wherein the first cross section of the tube is generally circular; and forming the second member from the tube includes changing the generally circular cross section to a generally square cross section. In one embodiment, producing the first member may include forming a tube from a flexible sheet material; wherein forming the second member may include forming a fold in the flexible sheet material in each of four selected regions of the tube; and extending each fold from proximate the first end of the tube to proximate the second end of the tube. In one embodiment, the method may further comprise reinforcing the flexible sheet material in each of the four selected regions of the tube prior to forming the fold therein.

In one embodiment, forming the tube from the flexible sheet material may include weaving a fabric on a circular loom. In one embodiment, reinforcing the fabric in the four selected regions may include weaving the fabric in the four selected regions to be of a first density and weaving the fabric in a rest of the tube to be of a second density, wherein the first density is greater than the second density. In one embodiment, weaving the fabric to be of the first density in the four selected regions may include weaving an increased number of warp threads in each of the four selected regions relative to a number of warp threads woven in the rest of the tube. In one embodiment, the method may further comprise moving two opposing regions of the flexible sheet material of the tube on either side of each fold into contact with one another to form a pleat. In one embodiment, the method may further comprise placing a lift belt along the pleat and parallel to the fold; extending a loop of the lift belt above the first end of the tube; and securing the lift belt and the pleat to one another. In one embodiment, placing the lift belt on the pleat may include folding the lift belt to form a first side and a second side; placing the first side and the second side of the lift belt in contact with one another; and placing the first side of the lift belt in contact with a first surface of the pleat. In one embodiment, placing the lift belt on the pleat may include folding the lift belt to form a first side and a second side; placing the first side of the lift belt in contact with a first surface of the pleat; and placing the second side of the lift belt in contact with a second surface of the pleat. In one embodiment, the method may further comprise extending the pleat outwardly beyond a rest of an exterior surface of the second member.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a top, front, left side perspective view of a first embodiment of a bulk bag for particulate materials in accordance with an aspect of the present disclosure.

FIG. 2A is a diagrammatic perspective view of a step in a method of making the bulk bag illustrated in FIG. 1 showing a tubular sleeve being fed into a folding machine.

FIG. 2B is a diagrammatic perspective view of a roll of folded material produced in the folding machine of FIG. 2A from the tubular sleeve.

FIG. 2C is a diagrammatic perspective view of a further step in the method of making a the bulk bag showing a length of the folded sleeve being cut from the roll of folded material.

FIG. 3 is a plan view of the a first end of the cut portion removed from the folded sleeve as shown in FIG. 2C.

FIG. 4A is an enlarged view of the highlighted portion of FIG. 3 showing a cross section of a pleat formed at an edge of the cut portion and showing the material of the pleat being of a greater density weave than an adjacent region of the cut portion.

FIG. 4B is an enlarged cross section view of the pleat similar to FIG. 4A showing the pleat moved to a closed condition and showing a lift belt positioned to be secured to one side surface of the pleat in a first manner.

FIG. 4C is an enlarged cross section view of the pleat similar to FIG. 4B and showing the lift belt secured to the one side of the pleat in the first manner.

FIG. 4D is a top, right side perspective view of the lift belt secured to the pleat in the first manner.

FIG. 4E is a top, left side, perspective view of the lift belt secured to the pleat in the first manner.

FIG. 5 is a top, front, left side perspective view of the cut portion with hemmed pleats and lift belts at each corner and sowing a bottom wall positioned for attachment to a lower end of the cut portion.

FIG. 6A is enlarged view of the highlighted portion of FIG. 3 identical to FIG. 4A and showing a cross section of the pleat formed at the edge of the sleeve.

FIG. 6B is an enlarged cross section view of the pleat similar to FIG. 6A, showing the pleat moved to a closed condition and showing a lift belt positioned to be secured to opposing sides of the pleat in a second manner.

FIG. 6C6C is an enlarged cross section view of the pleat similar to FIG. 6B showing the lift belt secured to the opposing sides of the pleat in the second manner.

FIG. 6D6D is a top, right side perspective view of the lift belt secured to the pleat in the second manner.

FIG. 6E6E is a top, left side perspective view of the lift belt secured to the pleat in the second manner.

FIG. 7 is a top, front, left side perspective view of a second embodiment of the bulk bag in accordance with an aspect of the present disclosure showing the lift belt secured to the cut portion in the second manner and further showing various dimensions of the bulk bag.

Similar numbers refer to similar parts throughout the drawings.

### DETAILED DESCRIPTION

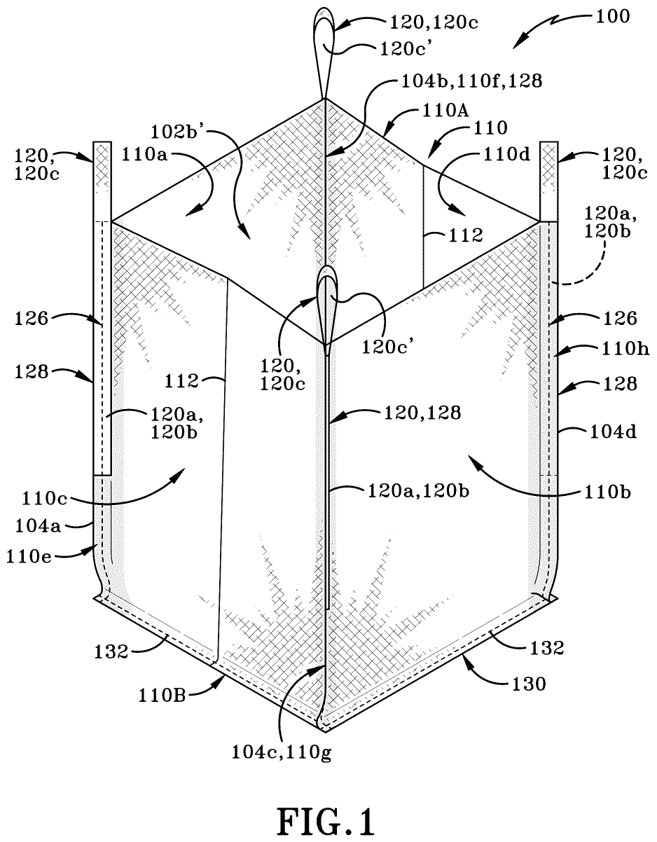

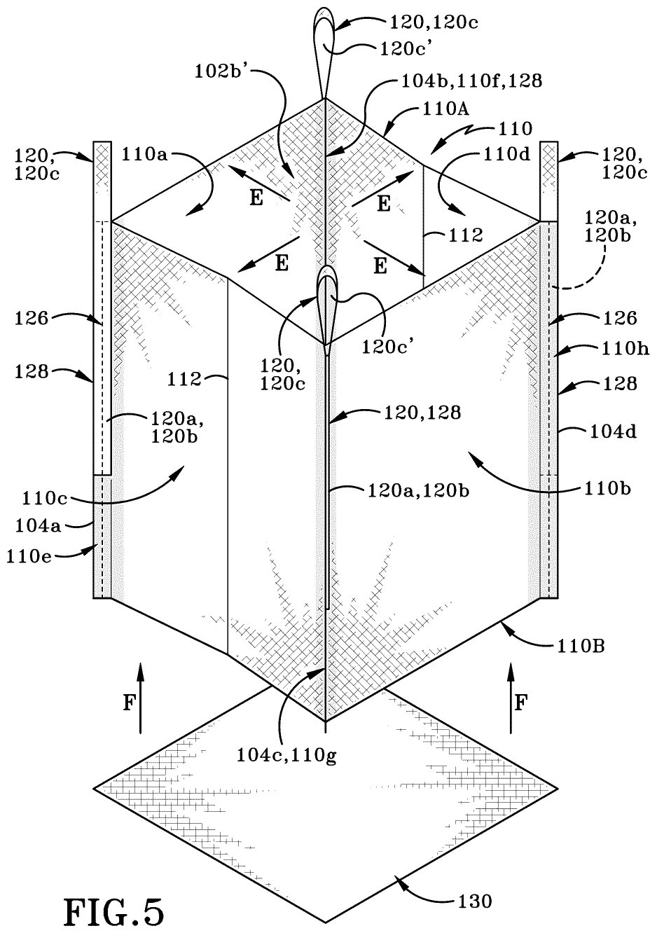

Referring to FIGS. 1-4E, there is shown a first embodiment of a bulk bag for particulate materials in accordance with an aspect of the present disclosure, generally indicated at 100. FIGS. 5A-7 show a second embodiment of a bulk bag in accordance with an aspect of the present disclosure, generally indicated at 200.

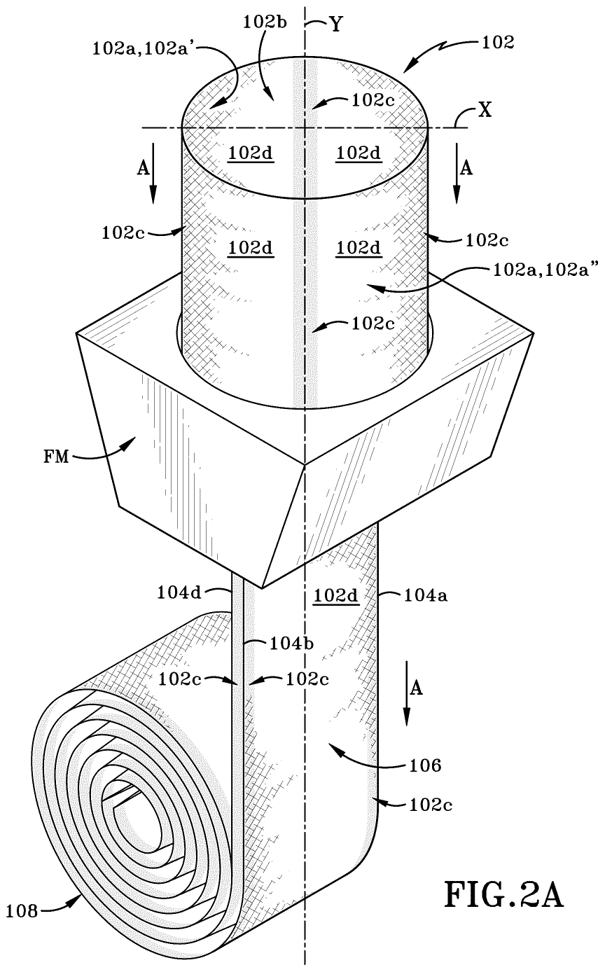

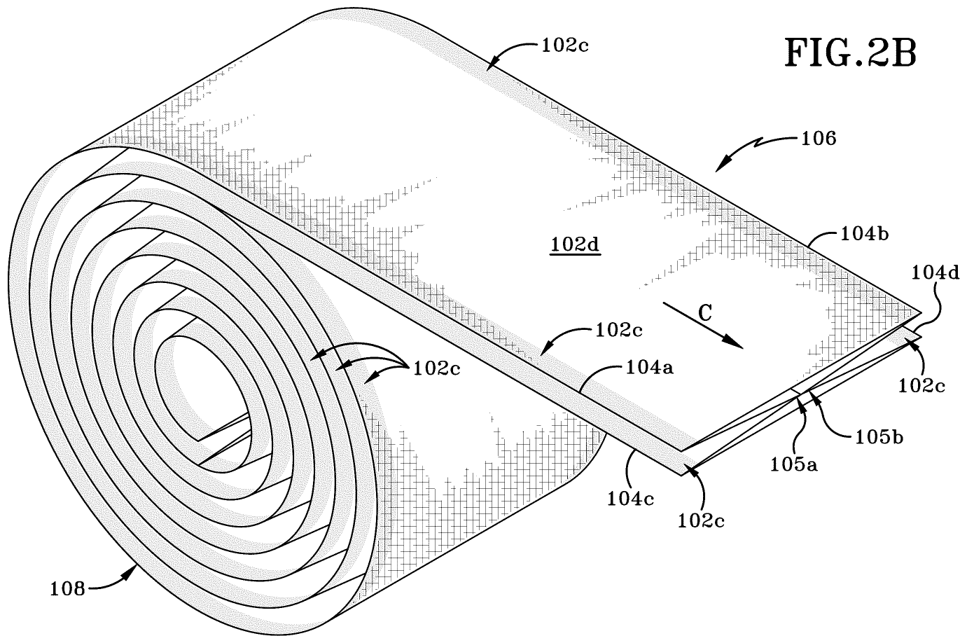

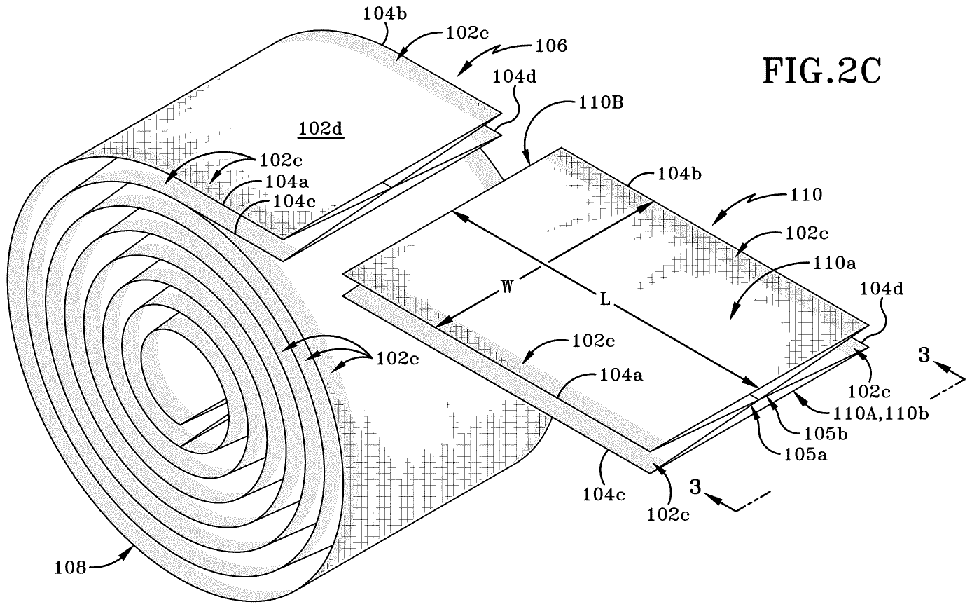

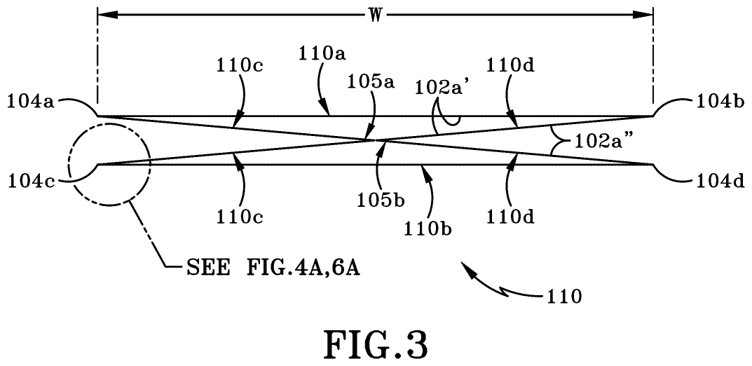

Referring to FIGS. 2A through 3, a method of forming bulk bag 100 (or bulk bag 200) is discussed. Bulk bag 100 may hereafter be referred to as “bag 100” and bulk bag 200 may be referred to as “bag 200”. The following description will relate to bag 100 and it's method of construction but it will be understood the description applies equally to bag 200.

FIG. 2A depicts a tubular sleeve 102 of indefinite length with a circumferential wall 102a having an interior surface 102a′ and an exterior surface 102a″. The interior surface 102a′ bounds and defines an interior bore 102b which extends through the tubular sleeve from a first open end to a second open end. FIG. 2A shows that tubular sleeve 102 is generally circular in cross section. The term “generally circular” is used herein to describe a cross section of a tubular sleeve 102 that may be a circle, an oval, an ellipse or any other continuous arcuate shape. Preferably, the generally circular tube is comprised of a fabric woven on a circular loom in such a way that there is no longitudinally-extending seam formed therein to create the generally circular shape.

Tubular sleeve 102 is comprised of a flexible sheet material such as a polymer or thermoplastic such polypropylene, polyethylene or nylon. Preferably, the tubular sleeve 102 is woven on a circular loom to form the continuous circumferential wall 102a of fabric. Tubular sleeve 102 has an imaginary longitudinal axis “Y” (FIG. 2A) and an imaginary lateral axis “X” oriented at ninety degrees to the longitudinal axis “Y”. The woven fabric includes warp threads (arranged parallel to the longitudinal axis “Y”) and weft threads (arranged parallel to the lateral axis “X”).

In accordance with an aspect of the present disclosure, the density of the weave of tubular sleeve 102 is not constant around the circumference of the woven fabric. As shown in FIG. 2A in particular, one or more regions of greater weave density are formed during the weaving of tubular sleeve 102. The regions of greater weave density are indicated by the grey-shaded areas shown in regions 102c of the drawings showing tubular sleeve 102. During the weaving process, additional warp threads (i.e., parallel to longitudinal axis “Y”) are provided in the reinforced regions 102c of tubular sleeve 102. The remainder of the circumferential wall 102a has fewer warp threads than the reinforced regions 102c. The regions of fewer warp threads are indicated in FIG. 2A by the reference number 102d. The provision of the additional warp yarns or threads contributes to the overall strength of the regions 102c and thereby to the strength of the bag. The reinforced regions may be marked by a tramline in the woven fabric.

In accordance with another aspect of the present disclosure, four regions 102c of woven into tubular sleeve 102. The four regions 102c are located circumferentially equidistant from one another around the circumference of tubular sleeve 102. The regions 102d of lesser thread density alternate the with regions 102c of greater thread density. The regions 102c of greater density in tubular sleeve 102 comprise reinforced areas in the circumferential wall 102a. In the illustrated embodiment, each of the regions 102c is about 6 inches wide but it will be understood that in other embodiments, the width of each of these regions may be less than 6 inches wide or greater than six inches wide. In one embodiment, the fabric weight in the regions 102d is around 230 GSM (Grams per Square Meter) and the fabric weight for the reinforced regions 102 c is around 349 GSM. In another embodiment, the fabric weight in the regions 102d is around 205 GSM and in the reinforced regions is around 305 GSM. The higher a fabric's GSM, the thicker and more durable that fabric is likely to be. Consequently, the reinforced regions 102c of tubular sleeve 102 are thicker and more durable than the other regions 102d.

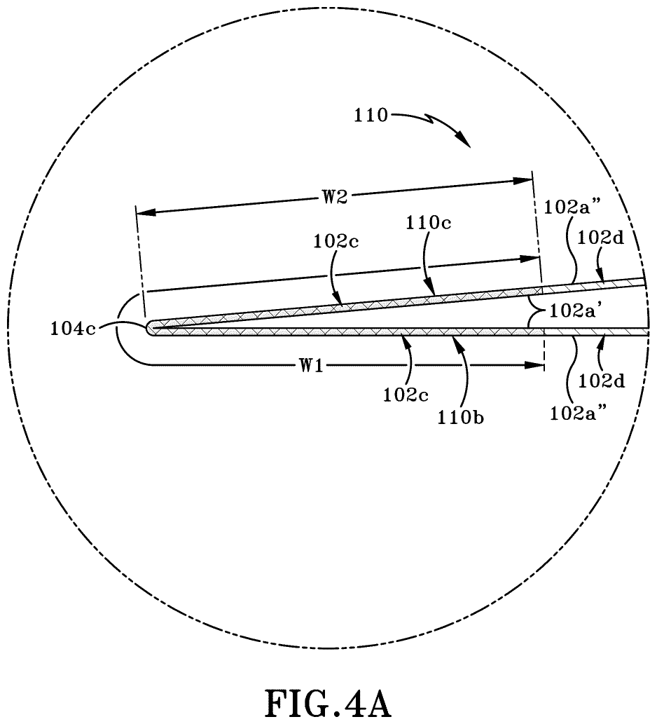

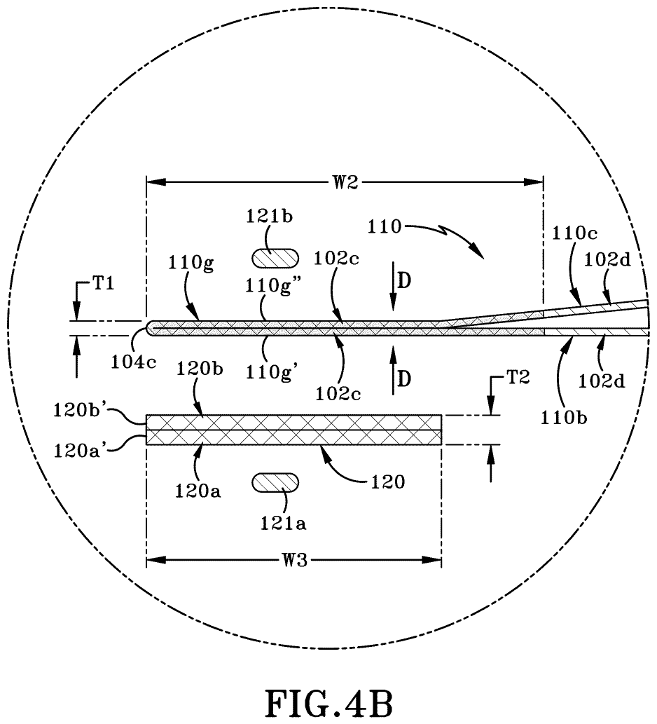

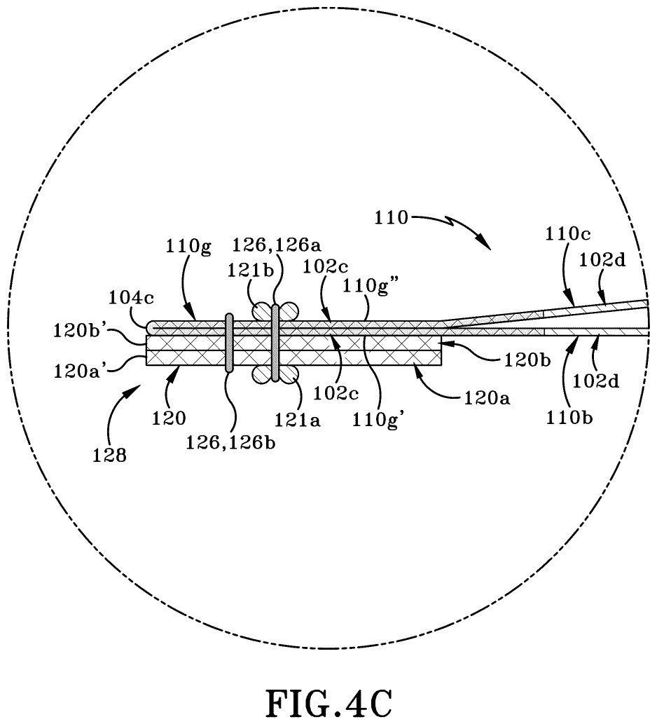

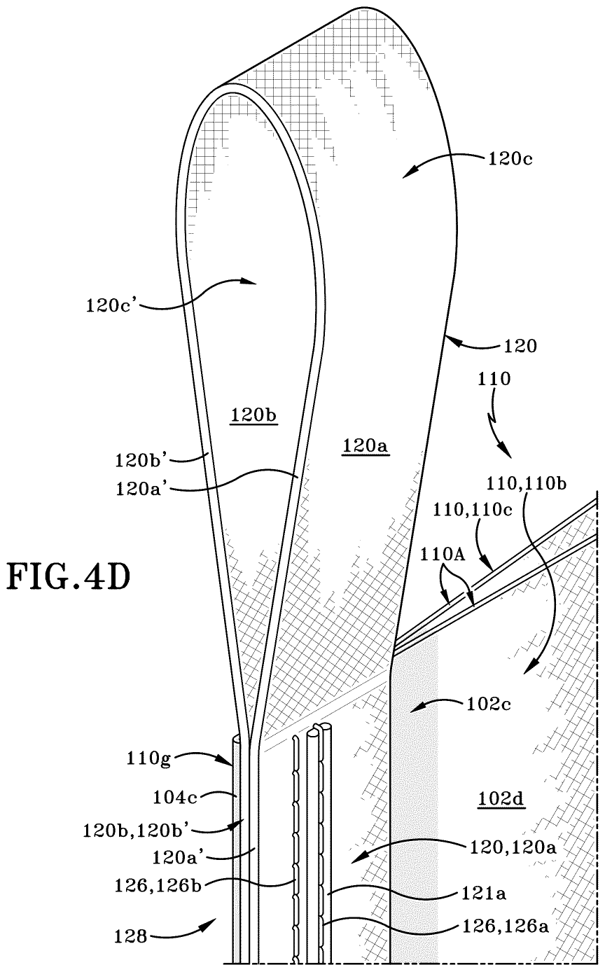

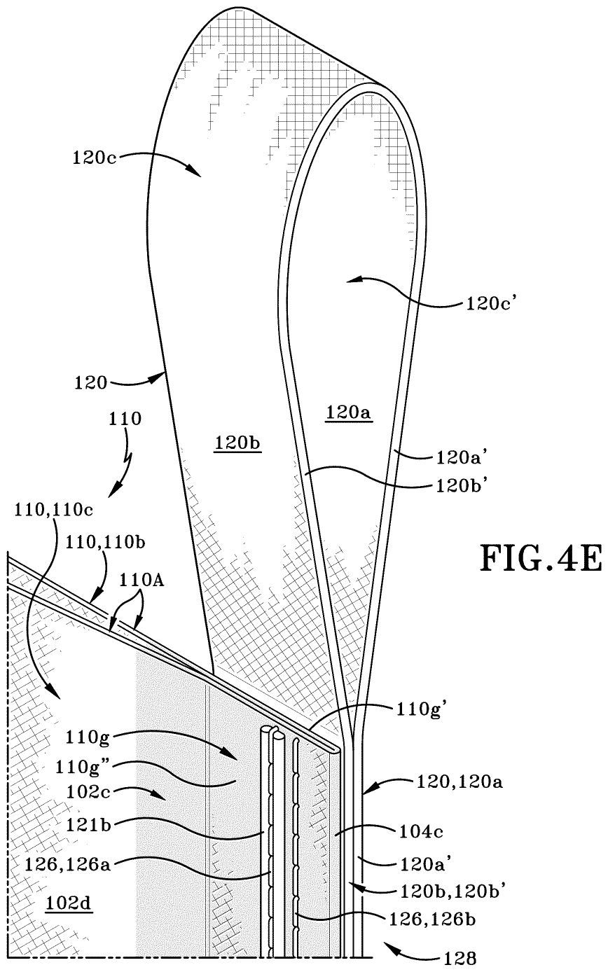

As shown diagrammatically in FIG. 2A, tubular sheet 102 is fed into a folding machine “FM” by motion in the direction of the arrow labelled “A”. Folding machine “FM” folds the fabric of tubular sleeve 102 in the reinforced regions 102c to form a longitudinally-extending fold in each reinforced region 102c and thereby creates a folded sleeve 106 (FIG. 2A). Folds 104 are formed in such a way that sections of the interior surface 102a′ (FIG. 4A) of the folded sleeve 106 are located adjacent one another. The folded sleeve 106 includes a first fold 104a, a second fold 104b, a third fold 104c and a fourth fold 104d. Each of the folds 104a, 104b, 104c, 104d extends longitudinally along the folded sleeve. As best seen in FIG. 3, in the folded sleeve 106 the first corner 104a is aligned with the third corner 104c and the second corner 104b is aligned with the fourth corner 104d.

As is evident particularly from FIG. 3, the folding machine “FM” produces two additional folds 105a, 105b in the folded sleeve 106. First fold 105a is located in a region of folded sleeve 106 that is intermediate first fold 104a and third fold 104c. In particular, first fold 105a is located midway between first fold 104a and third fold 104c. Similarly, second fold 105b is located in a region of folded sleeve 106 that is intermediate second fold 104b and fourth fold 104d. In particular, second fold 105b is located midway between second fold 104b and fourth fold 104d. In one embodiment, each fold 105a, 105b is formed in tubular sleeve 102 a distance of 18.5 inches (47 cm) away from the adjacent folds 104a, 104c or 104b, 104d, respectively. Folds 105a, 105b are not formed in regions of tubular sleeve which are of increased thread density. Instead, folds 105a, 105b are formed in the regions 102d of the tubular sleeve 102 (FIG. 2A) that are of lesser density than the regions 102c in which the folds 104a, 104b, 104c, and 104d are formed. Folds 105a, 105b are formed by causing part of the exterior surface 102a″ of the circumferential wall 102 of tubular sleeve 102 to come into contact with one another.

When the folded sleeve 106 exits folding machine “FM” in the direction indicated by arrow “B” in FIG. 2A, the generally circular cross-sectional shape of the tubular sleeve 102 which entered the folding machine “FM” has been altered. In particular, the folded sleeve 106 is a substantially flattened structure which may be rolled onto a spool or other carrier to form a roll 108 of the folded sleeve material. In other instances, the folded sleeve 106 may be moved on to other machinery to complete the assembly of the bulk bag 100.

When it is desired to form bulk bag 100 utilizing the folded sheet material, a length of the folded sleeve 106 is unrolled from roll 108, as indicated by arrow “C” in FIG. 2B. A portion 110 of the folded sleeve 106 is cut from the roll 108 in a desired length as illustrated in FIG. 2C. The cut portion 110 (or folded sleeve 106, flattened sleeve 104 or tubular sleeve 102) may also be referred to herein as the “first member”. The first member is transformed, as will be described hereafter, into a “second member”, i.e., bag 100 or bag 200.

The cut portion 110 has a first end 110A and an opposed second end 110B and is of a length “L” measured between first end 110A and second end 110B. The cut portion 110 furthermore is of a width “W” measured parallel to the lateral axis “X” of the cut portion 110 from first fold 104a to second fold 104b. In one embodiment, the width “W” may be about 37 inches (94 cm) long. Other features of cut portion 110 correspond to features noted in FIGS. 2A and 2B of folded sheet 106 on roll 108. As shown in FIGS. 1 and 3, cut portion 110 includes two opposing end walls 110a, 110b and two opposing side walls 110c, 110d. End wall 110a and end wall 110b are substantially planar in configuration and extend between first and second folds 104a, 104b and between third and fourth folds 104c, 104d, respectively. End walls 110a, 110b are each of the length “L” of cut portion 110 and the width “W” of cut portion 110.

The side walls 110c, 110d extend between first fold and third folds 104a, 104c and between second and fourth folds 104b, 104d, respectively. Each side wall includes a gusset 112 due to the presence of first fold 105a and second fold 105b, respectively. Side edges 110i are reinforced as reinforced areas 102c, as shown by shading indicated by number 102c. As seen in FIG. 2B, roll 108 may be unrolled by motion indicated by the arrow labelled “C”.

As mentioned earlier herein, tubular sleeve 102 and therefore folded sleeve 106 and cut portion 110 include four reinforced regions 102c where the thread density of the woven fabric is greater than a remaining portion thereof. Furthermore, the folds 104a, 104b, 104c, 104d in the folded sleeve 106 and therefore in the cut portion 110 are formed in these four reinforced regions 102c. The folded, reinforced regions constitute four pleats formed in the cut portion 110. These pleats are identified by the reference characters 110e, 110f, 110g and 110h. The pleats are identical in structure and function and vary only in their location and orientation relative to one another on cut portion 110. The pleat 110g is shown in detail in FIGS. 4A through 4E. FIG. 4A shows the total width “W1” of reinforced region 102c and the total width “W2” of the pleat 110g. As indicated earlier herein, in one embodiment, reinforced region 102 has a width “W1” of about 6 inches and since fold 104c is formed midway in reinforced region 102c, the width “W2” of pleat 110g will be about 3 inches (7.62 cm). FIG. 4B shows the second end 110b and first side 110c of cut portion 102 being moved toward one another in the directions indicated by arrows “D” to form the pleat 110g and further shows the pleat 110g is of a thickness “T1”. In one embodiment, the thickness of pleat may be from about 0.1 mm up to about 5 mm and is a measurement of the combined thickness of the second end 110b and first side 110c of the cut portion 110.

As is evident from FIG. 1, when pleats 110e, 110f, 110g, 110h are formed in cut portion 110 and the ends and sides of cut portion are secured to one another at each pleat (as will be described later herein), cut portion 110 is able to be expanded to provide access to a modified interior cavity 102b′. The modified interior cavity is generally square in cross section. The folding and pleating transforms tubular sleeve from a component which is generally circular in cross section (see FIG. 2A) to one which is generally square in cross section.

The perimeter of the expanded and opened cut portion 102 is equal to two times the width “W” of one of the ends 110a, 110b plus two times the width of one of the sides 110c, 110d The perimeter of the expanded and opened cut portion 110 is slightly less than the circumference of the tubular sleeve 102 from which the cut portion 102 is formed. In one embodiment, the total size of the perimeter of the pleated cut portion 102 is equal to four times the width “W” measured between first fold 104a and second fold 104b. In one embodiment, where the width “W” equals 37 inches (94 cm), the total perimeter of the pleated cut portion 102 is about 148 inches (376 cm). Other perimeter sizes are of course possible. When moved to an expanded or open position as indicated by arrows “E” in FIG. 5, cut portion 102 has a generally cuboid shape.

Once pleats 110e 110f, 110g, 110h are formed in the cut portion 110, a lift belt 120 is secured to each pleat. Lift belt 120 comprises a strap, particularly a fabric strap, which is of sufficient strength to enable a fully-loaded bag 100 to be lifted off a surface by the lift belts 120 and to be manipulated and moved. The bag 100 may be filled to an appropriate level with particulate materials and then the fully-loaded bag 100 may, for example, be lifted up off a ground surface and be loaded onto a truck for transportation. When a remote destination is reached, the lift belts 120 may be utilized to lift the fully-loaded bag 100 of the truck and be placed onto a surface at the remote location.

As best seen in FIGS. 4D and 4E, lift belt 120 comprises an elongate strap which is folded in half so as to form a first side 120a and second side 120b. The fold in lift belt 120 forms a loop 120c which, when lift belt 120 is engaged with one of the pleats 110e, 110f, 110g, 110h of cut portion 110, will extend beyond the first end 110A of cut portion 110. This can be seen in FIG. 1. Each loop 120c defines a through opening 120c′ (FIG. 4A) which is able to receive a suitable type of lifting mechanism therethrough when bulk bag 100 is to be lifted off of a surface.

FIG. 4B shows the installation of lift belt 120 with cut portion 102. As indicated above, lift belt 120 has two sides, 120a, 120b. Lift belt 120, when folded in half, is of a thickness “T2” (FIG. 4B) which is equal to double the thickness of either side 120a, 120b of the lift belt 120 In one embodiment, the thickness of first side 120a or second side 120 b may be from about 0.1 mm up to about 2 mm. The thickness “T2” of the folded lift belt 120 may therefore be about 0.2 mm up to about 4 mm. Lift belt 120 has a width “W3” which is illustrated in FIG. 4B as being smaller than width “W2” of pleat 110g. In other instances, the width “W3” of lift belt 120 may be equal to the width “W2” of pleat 110g. In one embodiment, the width “W2” of pleat 110g and the width “W3” of lift belt 120 may be from about 0.5 cm up to about 5 cm, however other values are possible.

FIG. 4B shows a first manner of securing lift belt 120 to pleat 110g of cut portion 110. (It will be understood that a similar lift belt 120 is secured to each of the other pleats 110e, 110f, and 110h in a substantially identical manner). In this first manner of securing lift belt 120 to pleat 110g, the first side 120a and second side 120b of lift belt 120 are placed in abutting contact with one another. Second side 120b is placed in abutting contact with the reinforced region 102c on second end 110b of cut portion 110. (It is understood that since first side 120a and second side 120b of lift belt 120 are identical to one another, first side 120a may alternatively be placed in abutting contact with second end 110b. Still further, either the first side 120a or second side 120b of lift belt 120 may be placed in abutting contact with the reinforced region 102c on first side 110c of cut portion 102.)

FIGS. 4B through 4E show a first backing member 121a is placed in abutting contact with an outermost surface of the first side 120a of lift belt 120 (if second side 120b contacts second end 110b), and a second backing 121b is placed in contact with first side 110c of cut portion 102. As best seen in FIG. 4B, the first backing 121a and second backing 121b are aligned with one another and are spaced a distance inwardly away from the fold 104c in pleat 110g and from the outermost ends 120a′, 12b0′ of lift belt 120. Lift belt 120 is then stitched to plate 110g. 110g

FIG. 4C depicts a view similar to that in FIG. 4 and shows pleat 110g and lift belt 120 engaged with one another and with first backing 121a and second backing 121b by sewing the components to one another via stiches 126. By way of example, first stiches 126a go through pleat 110g, lift belt 120 and first and second backing 121a and 121b. Second stitches 126b go through pleat 110g and lift belt 120 but does not go through first and second backing 121a, 121b. It will be understood that wider first and second backing 121a and 121b may be utilized and additional rows of stitches may be utilized to secure lift belt 120 to pleat 110g and to hold pleat 110g in a folded condition. Embodiments with one backing and one row of stitches are also possible. The engagement of pleat 110g, lift belt 120, backing 121 and stitches 126 forms a hemmed pleat 128. Such a hemmed pleat 128 is formed at each of the four corners of the cut portion 102. Each hemmed pleat 128 has a thickness which is equal the sum of the pleat thickness plus the lift belt thickness plus the thickness of the first and second back 121a, 121b. The four corners of the cut portion 102 are therefore reinforced not only by the provision of the greater GSM of the reinforced region 102c of the tubular sleeve 102 but also by the folding of a pleat into that reinforced region 102c and then the securement of the lift belt 120 and associated backing 121a, 121b in that same location. The four reinforced hemmed pleats 128 in the cut portion 102 along with the fact that the fabric used in the cut portion 102 is initially in the form of a tubular sleeve adds to the overall strength of the bulk bag 100 so produced. It should be noted from FIG. 1 that the lift belts 120 may not extend for the entire length of the associated pleat 110e, 110f, 110g, 110h down to the second end 110B (FIG. 2C) of cut portion 102. Instead, the lift belts 120 may be shorter than the overall length “L” (FIG. 2C) of the cut portion 102. In other embodiments, the lift belts 120 may extend all the way down to second end 110B of cut portion 102.

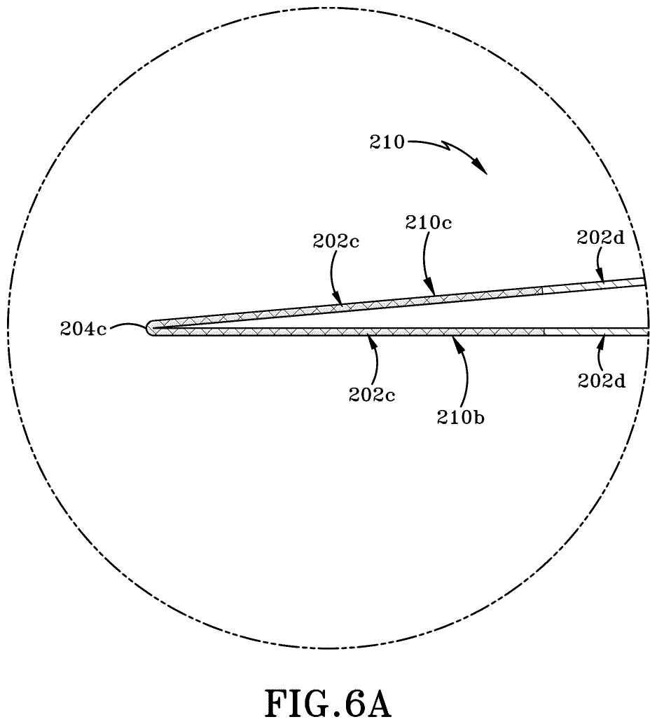

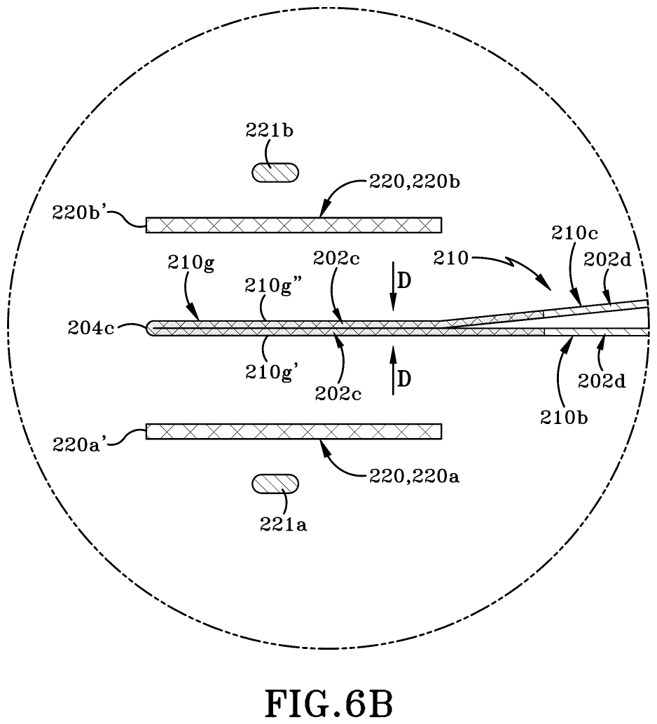

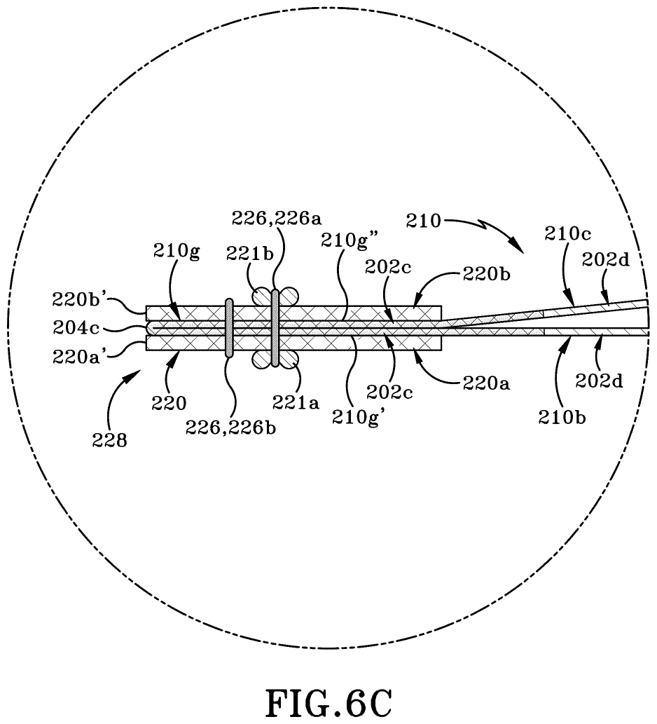

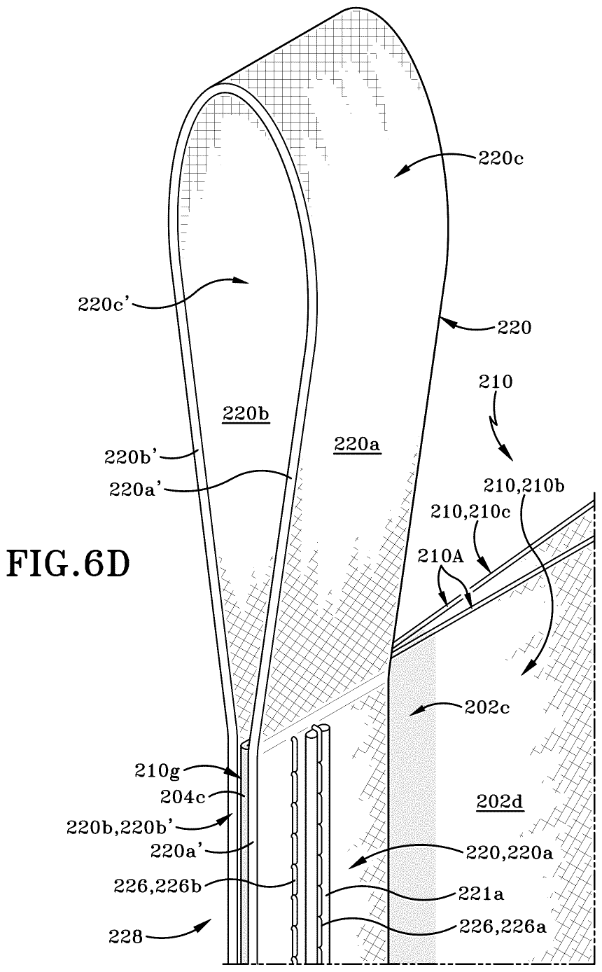

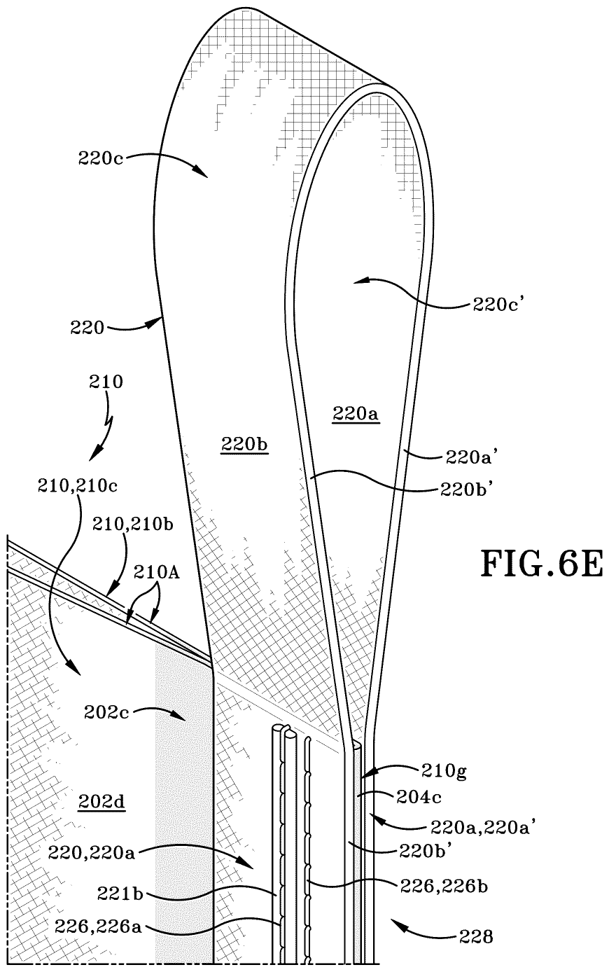

Referring now to FIG. 5, once the hemmed pleats 128 are formed in cut portion 102, the second end 110B therefore may be closed in any suitable manner. One suitable manner of closing off access to an opening defined by second end 110B of cut portion 102 is to sew a bottom wall 130 to the fabric adjacent second end 110B. The engagement of bottom wall 130 with cut portion 102 is indicated by arrows “F” in FIG. 5. Bottom wall 130 is selected to be of a suitable size to be sewn to cut portion 102 by way of stitches 132 (FIG. 1). Any other suitable manner of closing off access to the opening to the interior cavity 102b′ defined by second end 110B may be utilized. Additionally, a hem may be produced in second end 110B of cut portion and/or in the perimeter of bottom wall 130 prior to securing bottom wall 130 to cut portion 102 by stitches 132. Referring now to FIGS. 6A through 6E there is shown a second manner of securing a lift belt 220 to a cut portion 210 during fabrication of a bulk bag 200. Cut portion 210 is identical to cut portion 110 and therefore will not be described in any additional detail herein. Lift belt 220 is identical to lift belt 120 and therefore will not be described in any additional detail herein. Lift belt 220 is secured to cut portion 210 in a second manner that differs from the first manner in which lift belt 120 is secured to cut portion 110.

FIGS. 6A and 6B show an enlarged view of a pleat 210g formed from folding reinforced region 202c of cut portion 202 about a fold 204c. The reinforced region 202c is identical in structure and function to reinforced region 102c and therefore will not be described in any additional detail herein. Similarly, a region 202d of lower GSM than the reinforced region 202c is shown in this figure. The region 202d is identical to the region 102d and therefore will not be described in any additional detail herein. The fold 204c and pleat 210g are identical to fold 104c and pleat 110g and will therefore not be described in any additional detail herein. FIG. 6B depicts the construction of the pleat 210g and the engagement of lift belt 220 therewith. FIG. 6B shows the two adjacent portions 210b, 210c of wall 210 being moved toward one another in the direction indicated by arrows “D” to form pleat 210g. Lift belt 220 has two sides, 220a and 220b when folded in half. Lift belt 220 forms a loop 220c defining a through-aperture 220c′. An edge 220a′ of first side 220a of lift belt and a first side 220b′ of lift belt 220 are aligned with the corner 204c of pleat 210g. First side 220a and second side 220b are arranged differently relative to cut portion 210 in that an interior surface of first side 220a is placed in abutting contact with an exterior surface of second end 210b of cut portion 210 and an interior surface of second side 220b is placed in abutting contact with an exterior surface of first side 210c of cut portion 210 FIG. 6B also shows a first backing 221a placed in contact with an exterior surface of first side 220a of lift belt 220 and a second backing 221b placed in contact with an exterior surface of second side 220b of lift belt 220. FIGS. 6B and 6C shows edges 220a′ and 220b′ aligned with fold 204c and first backing 221a aligned with second backing 221b a distance inwardly from edges 220a′, 220b′. Stitches 226a secured first and second backing 22a, 221b, first side 220a, second side 220b, and the layers of pleat 210g to one another. Stitches 226b secured second end 210b and first side 210c of pleat 210g to one another. Like the first manner of securing lift belt 120 to cut portion 110, the second manner of securing lift belt 220 to cut portion 210 may include only one row of stiches or more than one row of stitches. When lift belt 220 is secured to pleat 210g in this second manner, a hemmed pleat 228 is provided at each corner of cut portion 210. (It will be understood that other ways of securing lift belt 220 to cut portion 210 other than sewing the same to one another may also be utilized.)

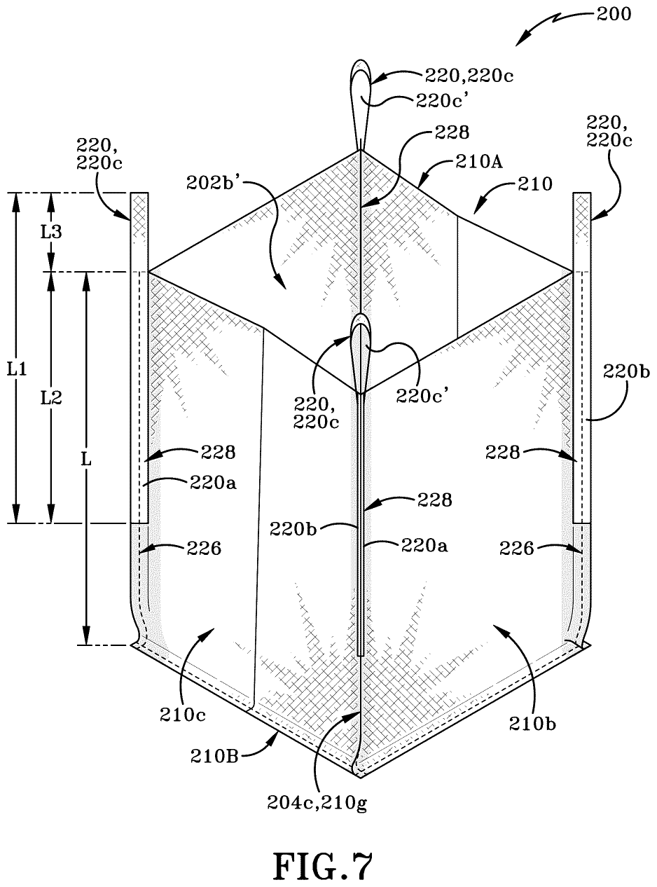

FIG. 7 depicts various dimensions related to a bulk bag 200 formed from the cut portion 210 and lift belts 220 shown in FIGS. 6A through 6E, and through closing off access to an interior cavity 202b′ in a similar manner to bulk bag 100 shown in FIG. 1. For example, a bottom wall may be engaged with cut portion 210 in a similar manner to the engagement of bottom wall 130 with cut portion 110 as shown in FIG. 5.

Bulk bag 200 is of a length “L” that is substantially equal to the length of the cut portion. The overall length of lift belt 220 is indicated in FIG. 7 as “L1”. Similar to in bag 100, lift belt 220 may not extend the full length of the hemmed pleats 228 but may terminate a distance upwardly from the second end 210B. In other embodiments, the lift belt 220 may extend at second end 210B. As illustrated in FIG. 7, the length of lift belt 220 which is incorporated into hemmed pleat 228 is indicated as length “L2” and the length of the loop 220c which extends above first end 210A of bag 200 is indicated as length “L3”. It will be understood that depending upon the end use of bag 200, the length “L” of bag 200, the length “L2” of lift belt 220, and the length “L3” of loop 220c on lift belt 220 may be varied.

By fabricating a tubular sleeve, increasing the fabric density in reinforced regions of the tubular sleeve, forming pleats in the reinforced regions, and then securing the lift belts in those pleated and reinforced regions in the first manner or the second manner described herein, the resultant bulk bags 100 and 200 tend to be stronger and more durable than previously known bags. Bags 100 and 200 also tend to be less prone to damage during lifting or if accidentally dropped.

In summary, a bulk bag 100, 200 for carrying a load of solid particulate materials and a method of constructing the bag are described herein. The bag 100, 200 includes a first member, i.e., tubular sleeve 102 (FIG. 2A) produced from a flexible sheet material. The flexible sheet material may be a woven fabric, particularly one woven on a circular loom. The tubular sleeve 102 is generally circular in cross-section. The first member, i.e., tubular sleeve 102 is transformed into a second member, i.e., bulk bag 100, 200 which is generally square in cross-section. The tubular sleeve 102 is woven in such a manner as to define a longitudinally extending bore 102b therethrough. In order to transform the first member, i.e., tubular sleeve 102, to the second member, i.e., bulk bag 100, 200, four longitudinally-extending reinforced regions 102c (FIG. 2A) are woven into the fabric of the tubular sleeve 102. A longitudinally-extending fold 104a is formed in each reinforced region 102c to create a pleat such as pleat 110g (FIG. 4A). In particular, four pleats 110e, 110f, 110g, and 110h are formed in the tubular sleeve 102. A lift belt 120 is secured along each pleat 110e, 110f, 110g, 110h in such a way that a loop 120c of each lift belt 120 extends beyond a first end 110A of a portion 110 cut from the woven tubular sleeve 102. A second end 110B of the cut portion 110 is closed off to transform the bore 102b of the tubular sleeve 102 into the cavity 102b′ of the bag 100, 200 for receiving the load of solid particulate materials therein.

During fabrication of bag 100, 200, the first member, i.e., tubular sleeve 102 includes a peripheral wall 102a (FIG. 2A) produced from the flexible sheet material, said peripheral wall 102a being generally circular in cross-section. A plurality of pleats 110e, 110f, 110g, 110f are formed in the peripheral wall 102a at circumferentially spaced-apart intervals from one another, such that each pleat extends longitudinally along the peripheral wall 102a, i.e., parallel to longitudinal axis “Y” (FIG. 2). A lift belt 120 is secured longitudinally along each pleat 110e, 110f, 110g, 110h. The peripheral wall 102a with the plurality of pleats 110e, 110f, 110g, 110h formed therein, along with the lift belt 120 secured to each pleat comprises the second member, i.e., bag 100, 200. The bag 100, 200 may further comprise a plurality of reinforced regions 102c provided in the peripheral wall 102a at the circumferentially spaced-apart intervals from one another, wherein adjacent reinforced regions 102c are separated from one another by unreinforced regions 102d. Each reinforced region extends longitudinally along the peripheral wall 102a, i.e., parallel to the longitudinal axis “Y”. Each pleat 110e, 110f, 110g, 110h is formed in a different one of the four reinforced regions 102c.

The flexible sheet material which forms the peripheral wall 102c preferably is a woven fabric, particularly one woven on a circular loom to give the peripheral wall 102c (FIG. 2A) it's tubular shape that is generally circular in cross section. The tubular sleeve 102 which is woven includes a plurality of regions 102c of a first thread density formed in the woven fabric and a rest of the woven fabric 102d is of a second thread density; wherein the first thread density is greater than the second thread density. In other words, the regions 102c are reinforced by increasing the thread density in those regions, particularly by increasing a number of warp threads woven in the regions 102c relative to the number of warp threads woven into the rest of the tubular sleeve 102, i.e., regions 102d. Each pleat 110e, 110f, 110g, 110h is formed in one of the plurality of regions of the first thread density, i.e., regions 102c.

The lift belt 120 which is placed longitudinally along each pleat, i.e., parallel to the longitudinal axis “Y”, includes a first side 120a and a second side 120b. One manner of securing the lift belt 120 to the associated pleat 110e, 110f, 110g, 110h includes placing the first side 120a and the second side 120b in abutting contact with one another and placing the first side 120a (or second side 120b) of the lift belt 120 in abutting contact with a first surface 110g′ or a second surface 110g″ (FIG. 4B) of the pleat 110g. The first surface 110g′ comprises a region of second end 110b of the cut portion 110 while the second surface 110g″ comprises a region of the first side 110c of the cut portion 110. The lift belt 120 is placed longitudinally along the pleat 110g in such a way that a loop 120c of the lift belt 120 extends outwardly beyond a first end 110A of the cut portion 110. (The cut portion 110 is being transformed into the second member, i.e., bag 100 through the formation of the pleats and the securement of a lift belt to each pleat.)

In another manner of securing the lift belt 220 (FIGS. 6A-6E) to the pleat 210g, for example, the first side 220a of the lift belt 220 is placed in abutting contact with a first surface 210g′ (which is on a region of second end 210b of the cut portion 210 as shown in FIG. 6B) of the pleat 210g and the second side 220b of the lift belt 220 is placed in abutting contact with a second surface 210g″ (on a region of side 210c) of the pleat 210g, wherein the first surface 210g′ and the second surface 210g″ of the pleat 210 are opposed to one another. In this instance as well, the loop of the lift belt 220 will extend outwardly beyond a first end of the cut portion 210 which is being transformed into the second member, i.e., bag 200 (FIG. 7).

A method of making a bag 100, 200 comprises producing a tube 102 of a flexible sheet material having at least a first portion 102c of a first density and at least a second portion 102d of a second density that is lower than the first density. The method further includes folding the tube 102 to form a substantially flat sheet 104. The method includes folding the tube 102 to form two planar faces 110a, 110b and two gusseted faces 110c, 110d. The method includes producing four folds 104a, 104b, 104c, 104d along which one of the two planar faces 110a, 110b intersects with one of the two gusseted faces 110c, 110d. The method includes weaving a fabric to form the flexible sheet material. The method further includes weaving the at least the first portion 102c of the first density to include more warp threads than the at least the second portion 102d of the second density. The method includes forming the four folds 104a, 104b, 104c, 104d in the at least the first portions 102c of the first density.

The method further includes rolling the substantially flat sheet 104 onto a spool to form a roll 108 of flattened tubular flexible sheet material. The method further includes unrolling a portion 106 of the substantially flat sheet 104 off the roll 108, cutting a desired length of the substantially flat sheet to obtain a cut portion 110 defining a first open end 110A and a second open end 110B, opening the substantially flat sheet of the cut portion 110 to form a cuboid shape (shown in FIG. 5). The method further includes attaching a bottom wall 130 (FIG. 5) to the second open end 110b of the cuboid shape to close off access to an interior cavity 102B′ defined by the cuboid shape. The method further includes attaching a fabric strip 120 (i.e., a lift belt) to each folded region 110e, 110f, 110g, 110h. Attaching of the fabric strip 120 includes providing an elongate fabric strip, folding the elongate fabric strip back on itself to form two substantially parallel sides 120a, 120b and a loop 120c, and attaching the two substantially parallel sides 120a, 120b to one or both surfaces of the at least one of the folded regions or pleats 110e, 110f, 110g, 110h. Pleat 110g, for example, has a first surface 110g′ which is located on second end 110b of cut portion 110, and a second surface 110g″ which is located on first side 110c of cut portion 110.

The method further includes sewing (with stitching 126—FIG. 4C through 4E) the fabric strip 120 to the at least the first portion 102c of the cut portion 110 having the first density. The method includes placing the fabric strip 120 against first surface 110g′ (or second surface 110g″) of pleat 110g, and then stitching the fabric strip 120 to the pleat 110g. Referring to FIG. 5B, the method may alternatively include placing a first side 220a of the fabric strip 220 in contact with the first surface 210g′ of the pleat 210g and placing the second side 220b of the fabric strip 220 in contact with the opposed second surface 210g″ of the pleat 210g and then stitching the fabric strip 220 to the folded region 210g.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A bag for carrying a load, said bag comprising:
a first member produced from a flexible sheet material, said first member being generally circular in cross-section;
a second member formed from the first member, said second member being generally square in cross-section; and
a cavity defined in the second member, said cavity being adapted to receive the load therein.

2. The bag according to claim 1, wherein the first member includes a peripheral wall produced from the flexible sheet material, said peripheral wall being tubular in configuration and extending longitudinally from a first end to a second end, wherein the peripheral wall is generally circular in cross-section.

3. The bag according to claim 2, further comprising:
a plurality of pleats formed in the peripheral wall at circumferentially spaced-apart intervals from one another, wherein each pleat of the plurality of pleats extends longitudinally along the peripheral wall;
a lift belt secured longitudinally along each pleat; and
wherein the peripheral wall with the plurality of pleats formed therein and the lift belt secured to each pleat comprises the second member.

4. The bag according to claim 3, further comprising:
a plurality of reinforced regions provided in the peripheral wall at the circumferentially spaced-apart intervals from one another;
wherein the plurality of reinforced regions extend longitudinally along the peripheral wall; and
wherein each pleat of the plurality of pleats is formed in a different reinforced region of the plurality of reinforced regions.

5. The bag according to claim 1, wherein the flexible sheet material which forms the peripheral wall comprises a woven fabric.

6. The bag according to claim 5, further comprising:
a plurality of regions of a first thread density formed in the woven fabric;
wherein a rest of the woven fabric is of a second thread density;
wherein the first thread density is greater than the second thread density; and
wherein each pleat of the plurality of pleats is formed in one of the plurality of regions of the first thread density.

7. The bag according to claim 1, wherein the lift belt comprises a first side and a second side, wherein the first side and the second side are in abutting contact with one another; wherein the first side is in abutting contact with a first surface of the pleat, and wherein a loop of the lift belt extends outwardly beyond a first end of the second member.

8. The bag according to claim 1, wherein the lift belt comprises a first side and a second side, wherein the first side is in abutting contact with a first surface of the pleat and the second side is in abutting contact with a second surface of the pleat, wherein the first surface and the second surface of the pleat are opposed, and wherein a loop of the lift belt extends outwardly beyond a first end of the second member.

9. A method of forming a bag comprising:
producing a first member having a first cross section;
defining a bore in the first member, wherein the bore extends through the first member from a first opening in a first end to a second opening in a second end;
forming a second member from the first member;
changing the first cross section of the first member to a second cross section of the second member, wherein the second cross section is different from the first cross section; and
closing the second opening to the bore to form a cavity in the second member, wherein the cavity is adapted to carry a load.

10. The method according to claim 9, wherein producing the first member includes:
producing a tube from a flexible sheet material;
wherein the first cross section of the tube is generally circular; and
forming the second member from the tube includes changing the generally circular cross section to a generally square cross section.

11. The method according to claim 9, wherein producing the first member includes:
forming a tube from a flexible sheet material;
wherein forming the second member includes forming a fold in the flexible sheet material in each of four selected regions of the tube; and
extending each fold from proximate the first end of the tube to proximate the second end of the tube.

12. The method according to claim 11, further comprising reinforcing the flexible sheet material in each of the four selected regions of the tube prior to forming the fold therein.

13. The method according to claim 12, wherein forming the tube from the flexible sheet material includes weaving a fabric on a circular loom.

14. The method according to claim 13, wherein reinforcing the fabric in the four selected regions includes weaving the fabric in the four selected regions to be of a first density and weaving the fabric in a rest of the tube to be of a second density, wherein the first density is greater than the second density.

15. The method according to claim 14, wherein weaving the fabric to be of the first density in the four selected regions includes weaving an increased number of warp threads in each of the four selected regions relative to a number of warp threads woven into the rest of the tube.

16. The method according to claim 12, further comprising moving two opposing regions of the flexible sheet material of the tube on either side of each fold into contact with one another to form a pleat.

17. The method according to claim 16, further comprising:
placing a lift belt along the pleat and parallel to the fold;
extending a loop of the lift belt above the first end of the tube; and
securing the lift belt and the pleat to one another.

18. The method according to claim 17, wherein placing the lift belt on the pleat includes:
folding the lift belt to form a first side and a second side;
placing the first side and the second side of the lift belt in contact with one another; and
placing the first side of the lift belt in contact with a first surface of the pleat.

19. The method according to claim 18, wherein placing the lift belt on the pleat includes:
folding the lift belt to form a first side and a second side;
placing the first side of the lift belt in contact with a first surface of the pleat; and
placing the second side of the lift belt in contact with a second surface of the pleat.

20. The method according to claim 16, further comprising extending the pleat outwardly beyond a rest of an exterior surface of the second member.
